(19) United States
(12) Patent Application Publication
(10) Pub. No.: US 2004/0204793 A1
(43) Pub. Date: Oct. 14, 2004

(54) Integrated controlled multi-air conditioner system

(76) Inventors: Sang Chul Yoon, Kyungki-do (KR); Duck Gu Jeon, Seoul (KR); Jae Sik Jung, Seoul (KR); Jae Hwan Kwon, Seoul (KR)

Correspondence Address: BIRCH STEWART KOLASCH & BIRCH, PO BOX 747, FALLS CHURCH, VA, 22040-0747, US

(21) Appl. No.: 10/729,987

(22) Filed: Dec. 9, 2003

(30) Foreign Application Priority Data
Dec. 10, 2002 (KR) 10-2002-0078331
Dec. 10, 2002 (KR) 10-2002-0078332

(51) Int. Cl. G05D 23/00; G06F 15/16; G01M 1/38; G05B 15/00

(52) U.S. Cl. 700/277; 709/230

(57) ABSTRACT

An integrated controlled multi-air conditioner system comprising a plurality of groups of indoor units, a plurality of outdoor units connected with the indoor unit groups, respectively, at least one local control unit connected in common with the outdoor units over an internal network for controlling operations of the outdoor units, and a protocol conversion unit connected with the local control unit. The protocol conversion unit is adapted to convert different communication protocols of data transmitted and received between an external Internet network and the internal network into each other to transfer a control command received over the external Internet network to at least one of the outdoor units. The multi-air conditioner system can be efficiently controlled from the internal network and external Internet network, resulting in a reduction in manpower and time for air conditioner management. The multi-air conditioner system is also economical in that it has a reduced number of public IP addresses assigned thereto.

### BACKGROUND OF THE INVENTION

1. Field of the Invention

The present invention relates to integrated controlled multi-air conditioner systems, and more particularly to an integrated controlled multi-air conditioner system wherein a protocol conversion unit is provided to convert different communication protocols into each other to simultaneously control the multi-air conditioner system over an internal network or an external Internet network, and an integrated control unit is provided to reduce the number of public Internet protocol (IP) addresses required for remote control over the Internet and increase a control manager's convenience.

2. Description of the Related Art

Recently, inexpensive and efficient air conditioner systems have been increasingly installed in large-scale buildings or homes. Such a typical air conditioner system has a plurality of indoor units installed within a large-scale building or home, and one outdoor unit connected in common with the indoor units for controlling refrigerant circulation and distribution with respect to the indoor units. In particular, in a place where the central control of internal air conditioning is required, such as a large-scale building, a plurality of air conditioner systems may be provided in all floors of the building, respectively. In this case, the air conditioner systems each include a plurality of indoor units installed within office rooms in a corresponding one of the floors, respectively, and one outdoor unit connected in common with the indoor units installed in the corresponding floor for controlling them. This overall system is typically called a multi-air conditioner system. This multi-air conditioner system has recently been increasingly used owing to the fact that it is lower in initial construction cost and maintenance/management cost than air conditioner systems each having an indoor unit and outdoor unit installed for every room.

With reference to FIG. 1, there is shown in block form the construction of such a conventional multi-air conditioner system. As shown in this drawing, the conventional multi-air conditioner system comprises a plurality of indoor units I1-In installed inside of a building, one outdoor unit O installed outside of the building and connected in common with the indoor units I1-In, and a control unit C installed in the outdoor unit O for controlling the indoor units I1-In.

Particularly, as home network systems have been in the spotlight, recently, the outdoor unit O has been implemented to be connected with an external Internet network for transmission and reception of data to/from external terminals. In this case, a user can input an indoor unit control command to the outdoor unit O by operating an Internet terminal such as an Internet accessible personal computer (PC).

In the conventional multi-air conditioner system with the above-mentioned construction, however, the outdoor unit O must be assigned a public IP address so that it can be accessed over the external Internet network. In this connection, in an apartment or large-scale building where a larger number of outdoor units are required because they must be installed in respective floors, a considerable amount of cost is required in assigning public IP addresses respectively to the outdoor units and there is a concern that the IP addresses could be wasted.

Further, since the outdoor units are provided in distinction from one another and assigned different public IP addresses, the user has to gain access to any one of the outdoor units connected with a specific indoor unit in the building over the external Internet network to control the specific indoor unit. For this reason, in the case of controlling a plurality of unspecified indoor units, the user cannot control the indoor units at one time and has the inconvenience of having to individually access outdoor units connected respectively with the indoor units.

### SUMMARY OF THE INVENTION

Therefore, the present invention has been made in view of the above problems, and it is an object of the present invention to provide an economical, integrated controlled multi-air conditioner system wherein a plurality of air conditioners can be controlled in an individual or integrated manner over an internal network and in a remote manner over an external Internet network, thereby increasing a control manager's convenience and saving time and cost required for controlling, managing and maintaining the air conditioners.

In accordance with one aspect of the present invention, the above and other objects can be accomplished by the provision of an integrated controlled multi-air conditioner system comprising a plurality of groups of indoor units; a plurality of outdoor units connected with the indoor unit groups, respectively; at least one local control means connected in common with the outdoor units over an internal network for controlling operations of the outdoor units; and protocol conversion means connected with the local control means, the protocol conversion means converting different communication protocols of data transmitted and received between an external Internet network and the internal network into each other to transfer a control command received over the external Internet network to at least one of the outdoor units.

In accordance with another aspect of the present invention, there is provided an integrated controlled multi-air conditioner system comprising a plurality of groups of indoor units; a plurality of outdoor units connected with the indoor unit groups, respectively; a plurality of local control means connected with the outdoor units over an internal network for controlling operations of the outdoor units, respectively; and a plurality of protocol conversion means networked with the plurality of local control means, respectively, each of the plurality of protocol conversion means converting different communication protocols of data transmitted and received between an external Internet network and the internal network into each other to transfer a control command received over the external Internet network to a corresponding one of the outdoor units.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a conventional multi-air conditioner system;

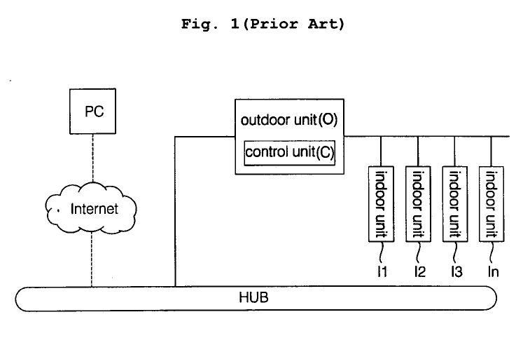

FIG. 2 is a block diagram showing the construction of an integrated controlled multi-air conditioner system in accordance with a first embodiment of the present invention;

FIG. 3 is a block diagram of a protocol conversion unit in accordance with the first embodiment of the present invention;

FIG. 4 is a block diagram of an integrated control unit in accordance with the first embodiment of the present invention;

FIG. 5 is a view showing a table stored in an IP translation/sharing unit in accordance with the first embodiment of the present invention;

FIG. 6 is a block diagram showing the construction of an integrated controlled multi-air conditioner system in accordance with a second embodiment of the present invention;

FIG. 7 is a block diagram showing the construction of an integrated controlled multi-air conditioner system in accordance with a third embodiment of the present invention;

FIG. 8 is a block diagram showing the construction of an integrated controlled multi-air conditioner system in accordance with a fourth embodiment of the present invention;

FIG. 9 is a block diagram showing the construction of an integrated controlled multi-air conditioner system in accordance with a fifth embodiment of the present invention; and

FIG. 10 is a view showing a table stored in an IP translation/sharing unit in accordance with the fifth embodiment of the present invention.

### DESCRIPTION OF THE PREFERRED EMBODIMENTS

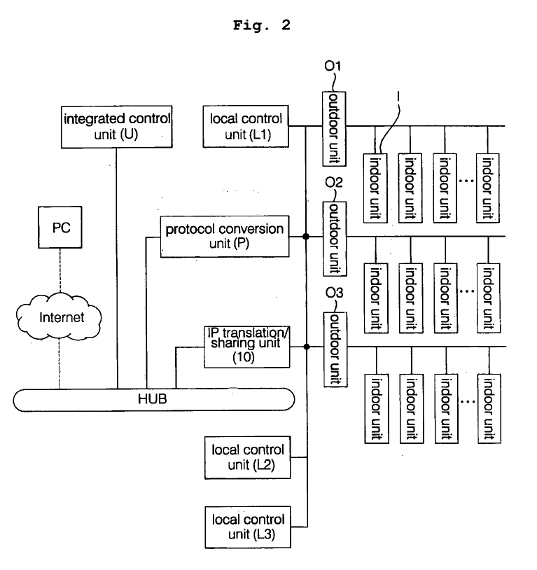

With reference to FIG. 2, there is shown in block form the construction of an integrated controlled multi-air conditioner system in accordance with a first embodiment of the present invention. As shown in this drawing, the integrated controlled multi-air conditioner system comprises a plurality of groups of indoor units I, a plurality of outdoor units O1-O3 connected with the indoor unit groups, respectively, a plurality of local control units L1-L3 connected with the outdoor units O1-O3, respectively, and a protocol conversion unit P connected in common with the local control units L1-L3 over an internal network for converting different communication protocols of data transmitted and received between an external Internet network and the internal network into each other so that the local control units L1-L3 can transmit and receive data to/from the external Internet network according to an Ethernet protocol.

Preferably, the local control units L1-L3 are each adapted to receive a control command and transfer the received control command to a corresponding one of the outdoor units O1-O3 connected to the internal network to control a corresponding one of the indoor unit groups connected with the corresponding outdoor unit in an integrated manner.

Alternatively, the local control units L1-L3 may be in communication with one another. In this case, each of the local control units L1-L3 can be connected with all of the outdoor units O1-O3 to transfer a control command thereto. Therefore, a user (or remote user) of the integrated controlled multi-air conditioner system according to the present invention can transfer a control command to the distributed outdoor units O1-O3 via any of the local control units L1-L3.

The integrated controlled multi-air conditioner system according to the present invention further comprises an integrated control unit U for simultaneously controlling the local control units L1-L3 in an integrated manner. The integrated control unit U is networked with the local control units L1-L3 via a hub, which concentrates transfer lines of all devices connected to the internal network at the center of the internal network and relays transmission and reception of data between the transfer lines and the external Internet network.

Accordingly, the remote user can control the air conditioner system without using a separate dedicated control device. For example, the remote user may gain access to the integrated control unit U by operating an Internet terminal accessible to the external Internet network. In this case, the integrated control unit U controls the air conditioner system by transferring a control command inputted from the remote user to the local control units L1-L3 over the internal network.

Note that the external Internet network is based on an Ethernet protocol (802.X) and the internal network is based on an RS-485 standard protocol. In this regard, the protocol conversion unit P is provided to convert the different communication protocols into each other to guarantee stability in the internal/external control of the multi-air conditioner system.

The integrated control unit U and protocol conversion unit P are assigned private IP addresses for their identification, respectively, because they are connected to the internal network. In this connection, the integrated controlled multi-air conditioner system according to the present invention further comprises an IP translation/sharing unit 10 for translating the private IP address of the integrated control unit U into a public IP address for connection with the external Internet network via the integrated control unit U, and, if an Internet terminal connected with the external Internet network, such as a PC, transmits a control command to the public IP address, translating the public IP address into the private IP address of the integrated control unit U or protocol conversion unit P and transferring the transmitted control command to the integrated control unit U or protocol conversion unit P on the basis of the translated private IP address.

The integrated control unit U, protocol conversion unit P and IP translation/sharing unit 10 are interconnected over the internal network to transmit and receive data to/from one another, and the hub is connected with the internal network to relay data transmitted and received between the internal network and the external Internet network.

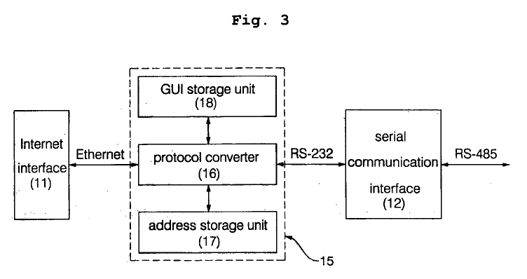

FIG. 3 is a block diagram of the protocol conversion unit P.

As shown in FIG. 3, the protocol conversion unit P includes an Internet interface 11 for transmitting and receiving data to/from the external Internet network according to the Ethernet protocol, a serial communication interface 12 connected with the local control units L1-L3 in a serial communication manner, and a communication control unit 15 for controlling transmission and reception of data between the Internet interface 11 and the serial communication interface 12. The communication control unit 15 includes a protocol converter 16 for converting the Ethernet protocol into a serial communication protocol to enable data communication with the outdoor units.

The communication control unit 15 further includes an address storage unit 17 for storing private IP addresses and port numbers assigned respectively to the local control units L1-L3. The protocol converter 16 is provided in the communication control unit 15 to convert different communication protocols of data transmitted and received between the Internet interface 11 and the serial communication interface 12 into each other. The communication control unit 15 further includes a graphic user interface (GUI) storage unit 18 for storing a GUI-based air conditioner control program for enabling the user to remotely control the local control units L1-L3 or outdoor units O1-O3 using an Internet terminal accessible to the Internet.

In particular, where the Internet terminal gains direct access to the protocol conversion unit P over the external Internet network, the GUI storage unit 18 sends the air conditioner control program to the Internet terminal over the external Internet network in response to a request therefrom. The Internet terminal may be, for example, a PC, notebook or Web pad accessible to the Internet.

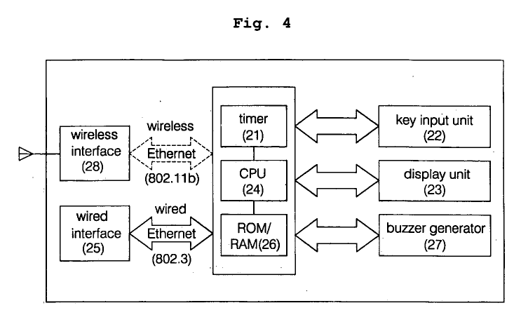

FIG. 4 is a block diagram of the integrated control unit U.

As shown in FIG. 4, the integrated control unit U includes a timer 21 for establishing synchronization of a control system of the integrated control unit U, a key input unit 22 for inputting commands for control of the operations of the outdoor units O1-O3, a display unit 23 for displaying the control commands inputted through the key input unit 22 and the associated outdoor unit/indoor unit control states, a central processing unit (CPU) 24 for controlling signal input and output of the key input unit 22 and display unit 23 and transmission and reception of data over the internal network, and a wired interface 25 for transmitting and receiving data between the CPU 24 and the protocol conversion unit P according to the Ethernet protocol.

The integrated control unit U further includes a read only memory (ROM)/random access memory (RAM) unit 26 connected with the CPU 24 for storing a program associated with the operation of the integrated control unit U and peripheral device drivers, and a buzzer generator 27 connected with the CPU 24. The integrated control unit U further includes a wireless interface 28 for transmitting and receiving data in a wireless manner.

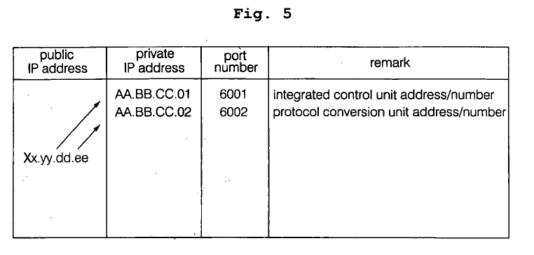

FIG. 5 shows a table stored in the IP translation/sharing unit 10. As shown in this drawing, the IP translation/sharing unit 10 stores a public IP address assigned to the multi-air conditioner system and private IP addresses and port numbers assigned respectively to the integrated control unit U and protocol conversion unit P in the form of a table. As a result, if an air conditioner control command is inputted to the public IP address xx.yy.dd.ee over the external Internet network, then the IP translation/sharing unit 10 transfers the inputted control command to the integrated control unit U or protocol conversion unit P on the basis of the private IP addresses and associated port numbers included in the table.

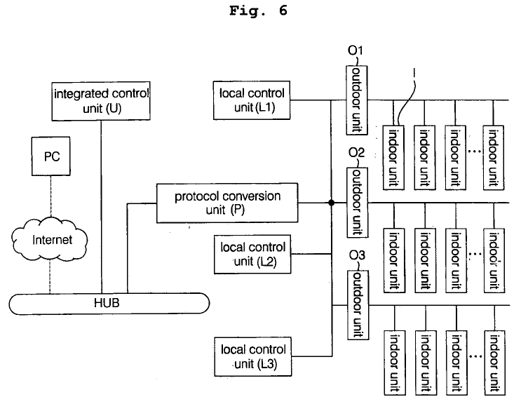

With reference to FIG. 6, there is shown in block form the construction of an integrated controlled multi-air conditioner system in accordance with a second embodiment of the present invention. The second embodiment is different in construction from the first embodiment in that it has no IP translation/sharing unit 10.

As shown in FIG. 6, the integrated controlled multi-air conditioner system comprises a plurality of groups of indoor units I, a plurality of outdoor units O1-O3 connected respectively with the indoor unit groups and in common with an internal network, a plurality of local control units L1-L3 connected with the internal network for controlling the outdoor units O1-O3, respectively, a protocol conversion unit P for converting different communication protocols of data transmitted and received between an external Internet network and the internal network into each other, namely, a communication protocol of the internal network and an Ethernet protocol, so that the local control units L1-L3 can transmit and receive data to/from the external Internet network, and an integrated control unit U assigned a public IP address so that it is externally accessible.

In the present embodiment, where an Internet terminal, such as a PC, gains access to the integrated control unit U through the public IP address assigned thereto and inputs an air conditioner control command, then the inputted control command is transferred to the protocol conversion unit P via a hub, which concentrates transfer lines of the integrated control unit U and protocol conversion unit P at the center of the internal network.

The protocol conversion unit P converts a communication protocol of the transferred control command into the communication protocol of the internal network so that the control command can be processed by the local control units L1-L3, and then sends the control command to a corresponding one of the local control units L1-L3.

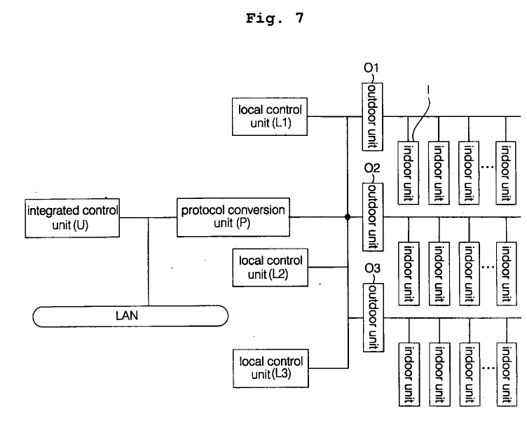

With reference to FIG. 7, there is shown in block form the construction of an integrated controlled multi-air conditioner system in accordance with a third embodiment of the present invention.

As shown in FIG. 7, the integrated controlled multi-air conditioner system comprises a plurality of groups of indoor units I, a plurality of outdoor units O1-O3 connected respectively with the indoor unit groups, a plurality of local control units L1-L3 each connectable with all of the outdoor units O1-O3, a protocol conversion unit P for converting different data communication protocols into each other so that the local control units L1-L3 can transmit and receive data over an internal network, and an integrated control unit U connected directly with the protocol conversion unit P for transferring a control command from an external Internet network to the protocol conversion unit P.

In the third embodiment, the integrated control unit U and the protocol conversion unit P are interconnected directly, not via a separate hub, thereby reducing costs required for system construction. The integrated control unit U transfers a control command inputted for integrated control by the user to the plurality of local control units L1-L3 via the protocol conversion unit P. Accordingly, the user can control the plurality of outdoor units O1-O3 and the plurality of groups of indoor units I at the same time.

The integrated control unit U in the third embodiment is assigned a public IP address so that it can transmit and receive data directly to/from the external Internet network, in a similar manner to that in the second embodiment.

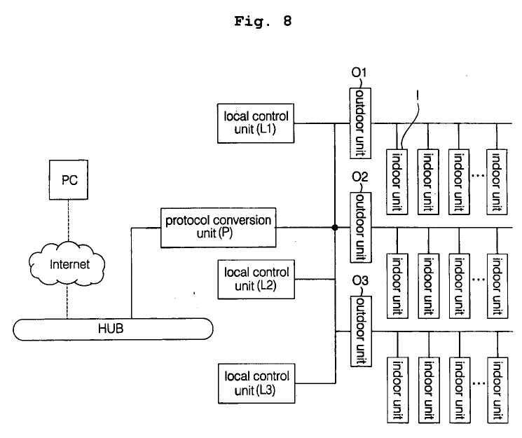

With reference to FIG. 8, there is shown in block form the construction of an integrated controlled multi-air conditioner system in accordance with a fourth embodiment of the present invention. As shown in this drawing, the integrated controlled multi-air conditioner system comprises a plurality of groups of indoor units I, a plurality of outdoor units O1-O3 connected respectively with the indoor unit groups, a plurality of local control units L1-L3 each connectable with all of the outdoor units O1-O3 for controlling the indoor units I and outdoor units O1-O3 from a local area, and a protocol conversion unit P for converting different data communication protocols into each other so that the local control units L1-L3 can be controlled over an external Internet network.

In the fourth embodiment, the protocol conversion unit P is assigned a public IP address so that it can transmit and receive data directly to/from the external Internet network. An Internet terminal connected to the external Internet network, such as a PC, can gain access to the protocol conversion unit P through the public IP address over the Internet network, download an air conditioner control program stored in the protocol conversion unit P, and input a command for the control of the plurality of indoor units or outdoor units according to the downloaded control program. The air conditioner control program is preferably implemented with a GUI to improve the convenience of the user's operation.

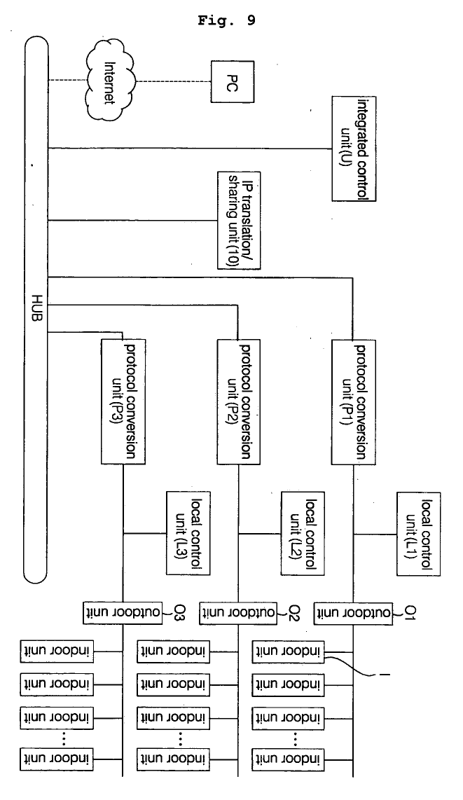

With reference to FIG. 9, there is shown in block form the construction of an integrated controlled multi-air conditioner system in accordance with a fifth embodiment of the present invention.

As shown in FIG. 9, the integrated controlled multi-air conditioner system comprises a plurality of groups of indoor units I, a plurality of outdoor units O1-O3 connected respectively with the indoor unit groups, a plurality of local control units L1-L3 each connected with a corresponding one of the outdoor units O1-O3 for controlling the corresponding outdoor unit and a corresponding one of the indoor unit groups connected with the corresponding outdoor unit from a local area, and a plurality of protocol conversion units P1-P3 connected respectively with the local control units L1-L3 for converting different communication protocols of data transmitted and received between an internal network and an external Internet network into each other.

The integrated controlled multi-air conditioner system further comprises an IP translation/sharing unit 10 for translating a public IP address into an internally designated private IP address, and an integrated control unit U for controlling the local control units L1-L3 in an integrated manner. The protocol conversion units P1-P3, which are one-to-one matched with the local control units L1-L3, the IP translation/sharing unit 10 and the integrated control unit U are concentrated at a hub so that they can be inter-networked.

In the fifth embodiment, the user can gain access to the integrated control unit U using an Internet terminal accessible to the external Internet network and input a control command thereto. At this time, the integrated control unit U sends the inputted control command to only one of the local control units L1-L3 connected with indoor units/outdoor unit corresponding to the control command, because the protocol conversion units P1-P3 are connected respectively with the local control units L1-L3. Therefore, as compared with the first to fourth embodiments each comprising the single protocol conversion unit P, the fifth embodiment has a shorter data transfer time and a reduced amount of workload, and thus a more stable data transfer capability.

That is, in the multi-air conditioner system implemented in the fifth embodiment, the integrated control unit U scans a specific indoor unit corresponding to a control command from only a list of indoor units managed by an outdoor unit connected with the specific indoor unit, because the protocol conversion units P1-P3 are connected respectively with the local control units L1-L3 as shown in FIG. 9. As a result, the scanning time becomes shorter, thereby realizing a higher communication speed.

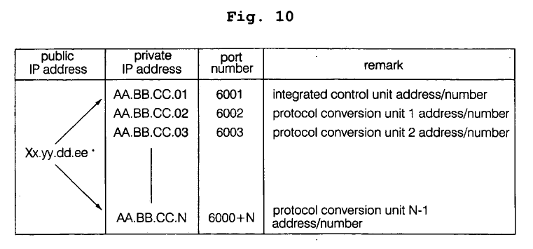

On the other hand, the IP translation/sharing unit 10 of the fifth embodiment has a table as shown in FIG. 10. The IP translation/sharing unit 10 translates a public IP address contained in a control signal transferred through the integrated control unit U into a private IP address and port number of a corresponding one of the local control units L1-L3 and then sends the control signal to the corresponding local control unit.

As apparent from the above description, the present invention provides an integrated controlled multi-air conditioner system wherein an integrated control unit is connected with a plurality of outdoor units over an internal network and is assigned a public IP address so as to be externally accessible, so that a plurality of indoor units and the outdoor units can be controlled in a remote manner over an external Internet network and in an integrated manner over the internal network. Therefore, the integrated controlled multi-air conditioner system is economical in that it prevents waste of manpower and time for air conditioner management. A protocol conversion unit is also provided in the system to convert different communication protocols of data transmitted and received between the internal network and the external Internet network into each other. Therefore, it is possible to prevent communication errors from occurring due to the different communication protocols and construct a more stable multi-air conditioner control system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An integrated controlled multi-air conditioner system comprising:
a plurality of groups of indoor units;
a plurality of outdoor units connected with said indoor unit groups, respectively;
at least one local control means connected in common with said outdoor units over an internal network for controlling operations of said outdoor units; and
protocol conversion means connected with said local control means, said protocol conversion means converting different communication protocols of data transmitted and received between an external Internet network and said internal network into each other to transfer a control command received over said external Internet network to at least one of said outdoor units.

2. The integrated controlled multi-air conditioner system as set forth in claim 1, further comprising integrated control means for transferring a control command to said outdoor units via said protocol conversion means to control said outdoor units in an integrated manner.

3. The integrated controlled multi-air conditioner system as set forth in claim 2, wherein said integrated control means is assigned a public Internet protocol (IP) address and a private IP address so that it is accessible from said external Internet network and internal network, respectively.

4. The integrated controlled multi-air conditioner system as set forth in claim 3, wherein said protocol conversion means is assigned a public IP address and a private IP address so that it is accessible from said external Internet network and internal network, respectively.

5. The integrated controlled multi-air conditioner system as set forth in claim 2, further comprising IP translation/sharing means assigned a public IP address so that it is controllable from said external Internet network, said IP translation/sharing means translating said public IP address contained in a control command received from said external Internet network into a private IP address and transferring the received control command to said integrated control means or protocol conversion means on the basis of the translated private IP address.

6. The integrated controlled multi-air conditioner system as set forth in claim 5, wherein said IP translation/sharing means is adapted to store a table including private IP addresses and port numbers assigned respectively to all devices connected to said internal network.

7. The integrated controlled multi-air conditioner system as set forth in claim 2, further comprising a hub for concentrating transfer lines of all devices connected to said internal network at a center of said internal network and relaying transmission and reception of data between said transfer lines and said external Internet network.

8. The integrated controlled multi-air conditioner system as set forth in claim 2, wherein said integrated control means includes:
a timer for establishing synchronization of a control system of said integrated control means;
a key input unit for inputting commands for control of the operations of said outdoor units;
a display unit for displaying the control commands inputted through said key input unit and the associated outdoor unit/indoor unit control states;
a central processing unit for controlling signal input and output of said key input unit and display unit and transmission and reception of data over said internal network; and
a wired interface for transmitting and receiving data between said central processing unit and said protocol conversion means according to an Ethernet protocol.

9. The integrated controlled multi-air conditioner system as set forth in claim 8, wherein said integrated control means further includes a wireless interface for transmitting and receiving data in a wireless manner based on a wireless Ethernet protocol.

10. The integrated controlled multi-air conditioner system as set forth in claim 2, wherein said protocol conversion means includes:
an Internet interface for transmitting and receiving data to/from said external Internet network according to an Ethernet protocol;
a serial communication interface for transmitting and receiving data to/from said local control means according to a serial communication protocol; and
communication control means for controlling transmission and reception of data between said Internet interface and said serial communication interface.

11. The integrated controlled multi-air conditioner system as set forth in claim 10, wherein said communication control means includes:
an address storage unit for storing a private IP address and port number assigned to said local control means; and
a protocol converter for converting different communication protocols of data transmitted and received between said Internet interface and said serial communication interface into each other.

12. The integrated controlled multi-air conditioner system as set forth in claim 11, wherein said communication control means further includes a graphic user interface (GUI) storage unit for storing a GUI-based air conditioner control program for enabling a user to remotely control said local control means or outdoor units using an Internet terminal accessible to said external Internet network.

13. The integrated controlled multi-air conditioner system as set forth in claim 12, wherein said GUI storage unit is adapted to send said air conditioner control program over said external Internet network in response to a request from said Internet terminal.

14. An integrated controlled multi-air conditioner system comprising:
a plurality of groups of indoor units;
a plurality of outdoor units connected with said indoor unit groups, respectively;
a plurality of local control means connected with said outdoor units over an internal network for controlling operations of said outdoor units, respectively; and
a plurality of protocol conversion means networked with said plurality of local control means, respectively, each of said plurality of protocol conversion means converting different communication protocols of data transmitted and received between an external Internet network and said internal network into each other to transfer a control command received over said external Internet network to a corresponding one of said outdoor units.

15. The integrated controlled multi-air conditioner system as set forth in claim 14, further comprising integrated control means for transferring a control command to said outdoor units via said protocol conversion means to control said outdoor units in an integrated manner.

16. The integrated controlled multi-air conditioner system as set forth in claim 15, wherein said integrated control means is assigned a public Internet protocol (IP) address and a private IP address so that it is accessible from said external Internet network and internal network, respectively.

17. The integrated controlled multi-air conditioner system as set forth in claim 15, wherein said protocol conversion means is assigned a public IP address and a private IP address so that it is accessible from said external Internet network and internal network, respectively.

18. The integrated controlled multi-air conditioner system as set forth in claim 15, further comprising IP translation/sharing means assigned a public IP address so that it is controllable from said external Internet network, said IP translation/sharing means translating said public IP address contained in a control command received from said external Internet network into a private IP address and transferring the received control command to said integrated control means or protocol conversion means on the basis of the translated private IP address.

19. The integrated controlled multi-air conditioner system as set forth in claim 18, wherein said IP translation/sharing means is adapted to store a table including private IP addresses and port numbers assigned respectively to all devices connected to said internal network.

20. The integrated controlled multi-air conditioner system as set forth in claim 15, further comprising a hub for concentrating transfer lines of all devices connected to said internal network at a center of said internal network and relaying transmission and reception of data between said transfer lines and said external Internet network.

21. The integrated controlled multi-air conditioner system as set forth in claim 15, wherein said integrated control means includes:
a timer for establishing synchronization of a control system of said integrated control means;
a key input unit for inputting commands for control of the operations of said outdoor units;
a display unit for displaying the control commands inputted through said key input unit and the associated outdoor unit/indoor unit control states;
a central processing unit for controlling signal input and output of said key input unit and display unit and transmission and reception of data over said internal network; and
a wired interface for transmitting and receiving data between said central processing unit and said protocol conversion means according to an Ethernet protocol.

22. The integrated controlled multi-air conditioner system as set forth in claim 21, wherein said integrated control means further includes a wireless interface for transmitting and receiving data in a wireless manner based on a wireless Ethernet protocol.

23. The integrated controlled multi-air conditioner system as set forth in claim 15, wherein said protocol conversion means includes:
an Internet interface for transmitting and receiving data to/from said external Internet network according to an Ethernet protocol;
a serial communication interface for transmitting and receiving data to/from said local control means according to a serial communication protocol; and
communication control means for controlling transmission and reception of data between said Internet interface and said serial communication interface.

24. The integrated controlled multi-air conditioner system as set, forth in claim 23, wherein said communication control means includes:
an address storage unit for storing a private IP address and port number assigned to said local control means; and
a protocol converter for converting different communication protocols of data transmitted and received between said Internet interface and said serial communication interface into each other.

25. The integrated controlled multi-air conditioner system as set forth in claim 24, wherein said communication control means further includes a graphic user interface (GUI) storage unit for storing a GUI-based air conditioner control program for enabling a user to remotely control said local control means or outdoor units using an Internet terminal accessible to said external Internet network.

26. The integrated controlled multi-air conditioner system as set forth in claim 25, wherein said GUI storage unit is adapted to send said air conditioner control program over said external Internet network in response to a request from said Internet terminal.
